(19) United States
(12) Patent Application Publication
(10) Pub. No.: US 2005/0204196 A1
(43) Pub. Date: Sep. 15, 2005

(54) Substrate processing apparatus and substrate processing method

(76) Inventors: Joichi Nishimura, Kyoto-shi (JP); Masami Ohtani, Kyoto-shi (JP)

Correspondence Address: OSTROLENK FABER GERB & SOFFEN, 1180 AVENUE OF THE AMERICAS, NEW YORK, NY, 100368403, US

(21) Appl. No.: 11/078,192

(22) Filed: Mar. 11, 2005

(30) Foreign Application Priority Data
Mar. 11, 2004 (JP) 2004-68553

(51) Int. Cl. G06F 11/00

(52) U.S. Cl. 714/31

(57) ABSTRACT

A moving image representing a maintenance method is reflected on a moving image display section in an operation panel. A worker can grasp the maintenance method by seeing the moving image displayed on the moving image display section. Consequently, maintenance can be performed in a short time and accurately in accordance with the moving image displayed on the moving image display section.

### BACKGROUND OF THE INVENTION

1. Field of the Invention

The present invention relates to a substrate processing apparatus and a substrate processing method for subjecting a substrate to predetermined processing.

2. Description of the Background Art

In recent years, substrate processing apparatuses provided with a plurality of processing units such as liquid processing units and thermal processing units have been developed. In the substrate processing apparatus, a substrate must be subjected to a series of processings. Therefore, there is provided a substrate transport robot capable of carrying the substrate among the plurality of processing units.

A substrate processing apparatus in which in a case where a trouble arises in a substrate transport robot, predetermined information related to the trouble is displayed on an operation panel has been developed (see JP-A-11-307612). In the substrate processing apparatus, when a trouble arises, the procedure for return from the trouble is displayed on the operation panel.

Since the procedure for return from the trouble displayed on the operation panel in the substrate processing apparatus is more simply displayed in characters, however, a further detailed instruction manual must be read in order to return from the trouble, so that it takes time and labor.

### SUMMARY OF THE INVENTION

An object of the present invention is to provide a substrate processing apparatus and a substrate processing method capable of performing maintenance in a short time and accurately.

A substrate processing apparatus according to an aspect of the present invention is a substrate processing apparatus that subjects a substrate to predetermined processing, comprising a storage device that stores moving image information: representing a method of maintaining the substrate processing apparatus, and a display device that displays the moving image information stored in the storage device as a moving image.

In the substrate processing apparatus, the moving image information representing the maintenance method is stored by the storage device, and the stored moving image information is displayed as the moving image by the display device.

In this case, a worker can easily grasp the method of maintaining the substrate processing apparatus by seeing the displayed moving image. Consequently, the maintenance can be performed in a short time and accurately.

The storage device may further store time information relating to a time period required for the maintenance, and the display device may display the time information relating to the time period required for the maintenance stored in the storage device.

In this case, the worker can estimate a working time period on the basis of the displayed time information.

The storage device may further store positional information relating to a position to be maintained, and the display device may display the positional information relating to the position to be maintained stored in the storage device.

In this case, the worker can easily grasp the position to be maintained in the substrate processing apparatus on the basis of the displayed positional information.

The storage device may further store adjustment value information relating to a value to be adjusted in the maintenance, and the display device may display the adjustment value information relating to the value to be adjusted in the maintenance stored in the storage device.

In this case, the worker can easily grasp the value to be adjusted on the basis of the displayed adjustment value information. Consequently, the adjustment can be made in a short time without repeating the adjustment.

The storage device may further store character information representing the maintenance method, and the display device may display the character information representing the maintenance method stored in the storage device.

In this case, the worker can easily grasp the maintenance method by seeing the displayed moving image and characters. Consequently, the maintenance can be performed in a shorter time and more accurately.

The character information representing the maintenance method may include character information indicated in a plurality of languages. The substrate processing apparatus may further comprise an operation unit that selects the character information indicated in the plurality of languages stored in the storage device. The display device may display the character information indicated in the languages selected by an operation of the operation unit.

In this case, the worker can easily grasp the maintenance method by selecting the character information indicated in the language which can be understood by himself or herself and seeing the displayed moving image and characters. Consequently, the maintenance can be performed in a shorter time and more accurately.

The storage device may further store character information representing the maintenance method, and the substrate processing apparatus may further comprise a voice output device that outputs the maintenance method stored in the storage device by voice.

In this case, the worker can easily grasp the maintenance method by seeing the displayed moving image as well as listening to description by voice. Consequently, the maintenance can be performed in a shorter time and more accurately.

The character information representing the maintenance method may include character information indicated in a plurality of languages. The substrate processing apparatus may further comprise an operator that selects the character information indicated in the plurality of languages stored in the storage device. The voice output device may output the character information indicated in the languages selected by an operation of the operation unit by voice.

In this case, the worker can easily grasp the maintenance method by selecting the character information indicated in the language which can be understood by himself or herself and seeing the displayed moving image and listening to description by voice. Consequently, the maintenance can be performed in a shorter time and more accurately.

The storage device may further store notification information for notifying the worker of the time when maintenance is to be performed, and the display device may display the notification information for notifying the worker of the time when maintenance is to be performed stored in the storage device.

In this case, the worker can easily grasp the time when maintenance is to be performed by seeing the displayed notification information. Consequently, it is possible to prevent the time when maintenance is to be performed from being forgotten.

The substrate processing apparatus may further comprise an alarm output device that outputs an alarm to the worker on the basis of the notification information.

In this case, the worker can reliably perform the maintenance without forgetting the notification information because the alarm is outputted by the alarm output device on the basis of the notification information.

The alarm output device may output an alarm sound on the basis of the notification information. In this case, the worker can reliably grasp the notification information by the alarm sound.

The alarm output device may display an alarm on the basis of the notification information. In this case, the worker can reliably grasp the notification information by the display of the alarm.

The storage device may further store history information relating to the history of the maintenance of the substrate processing apparatus. In this case, the worker can grasp the maintenance conditions of each of substrate processing apparatuses on the basis of the history information.

The display device may further display information indicating whether or not the maintenance of each unit in the substrate processing apparatus is required. In this case, the worker can easily judge whether or not the maintenance of each unit in the substrate processing apparatus is required.

The display device may switch and display the information indicating whether or not the maintenance is required and the moving image information. In this case, the information indicating whether or not the maintenance is required and the moving image information can be displayed without increasing the size of the display device.

A substrate processing method according to another aspect of the present invention is a substrate processing method for subjecting a substrate to predetermined processing, comprising the steps of storing moving image information representing a method of maintaining a substrate processing apparatus, and displaying the stored moving image information as a moving image.

In the substrate processing method, the moving image information representing the maintenance method is stored, and the stored moving image information is displayed as the moving image.

In this case, the worker can easily grasp the method of maintaining the substrate processing apparatus by seeing the displayed moving image. Consequently, the maintenance can be performed in a short time and accurately.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing the configuration of a substrate processing apparatus according to the present embodiment;

FIG. 2 is a diagram for explaining the configuration of a multi-stage thermal processing unit shown in FIG. 1;

FIG. 3 is a block diagram for explaining the relationship with a controller and an operation panel in the substrate processing apparatus shown in FIG. 1;

FIG. 4 is a perspective view showing the appearance of a substrate transport robot shown in FIG. 1;

FIG. 5 is a diagram showing a condition confirmation screen displayed on the operation panel;

FIG. 6 is a diagram showing a state where a maintenance screen is displayed on the operation panel;

FIG. 7 is a diagram showing a state where a maintenance screen is displayed on the operation panel;

FIG. 8 is a diagram showing a state where a maintenance screen is displayed on the operation panel;

FIG. 9 is a diagram showing a state where a detailed sentence screen is displayed on the operation panel; and

FIG. 10 is a diagram showing a state where a maintenance history screen is displayed on the operation panel.

### DESCRIPTION OF THE PREFERRED EMBODIMENTS

An embodiment of the present invention will be described while referring to the drawings.

In the following description, examples of a substrate include a semiconductor wafer, a glass substrate for a liquid crystal display device, a glass substrate for a PDP (Plasma Display Panel), a glass substrate for a photo mask, and a substrate for an optical disk.

### (1) First Embodiment

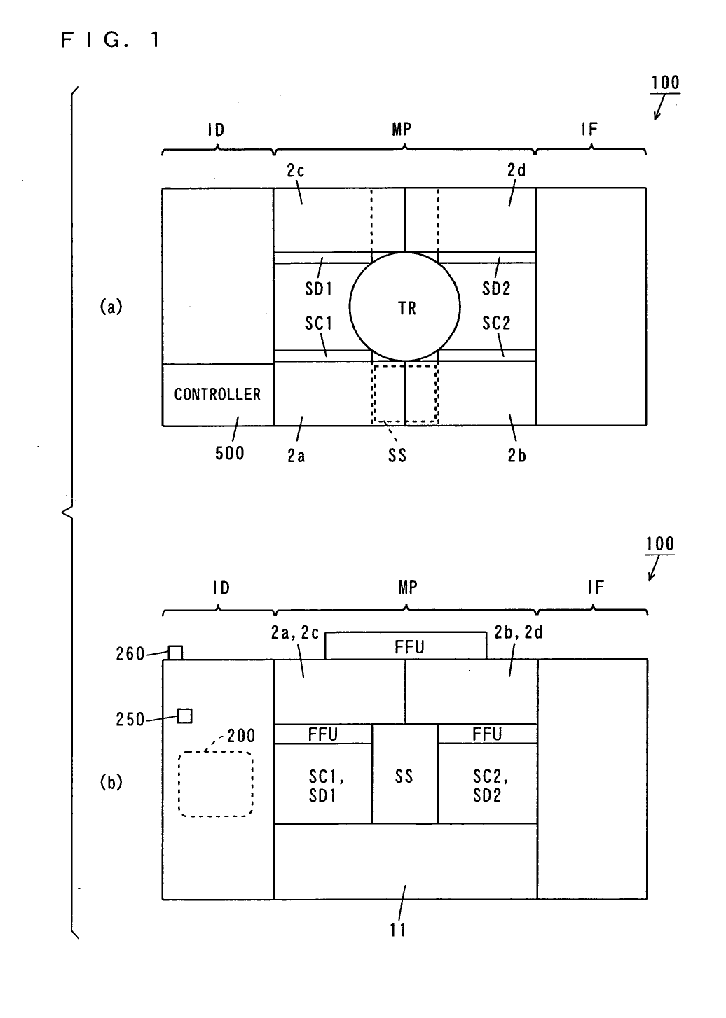

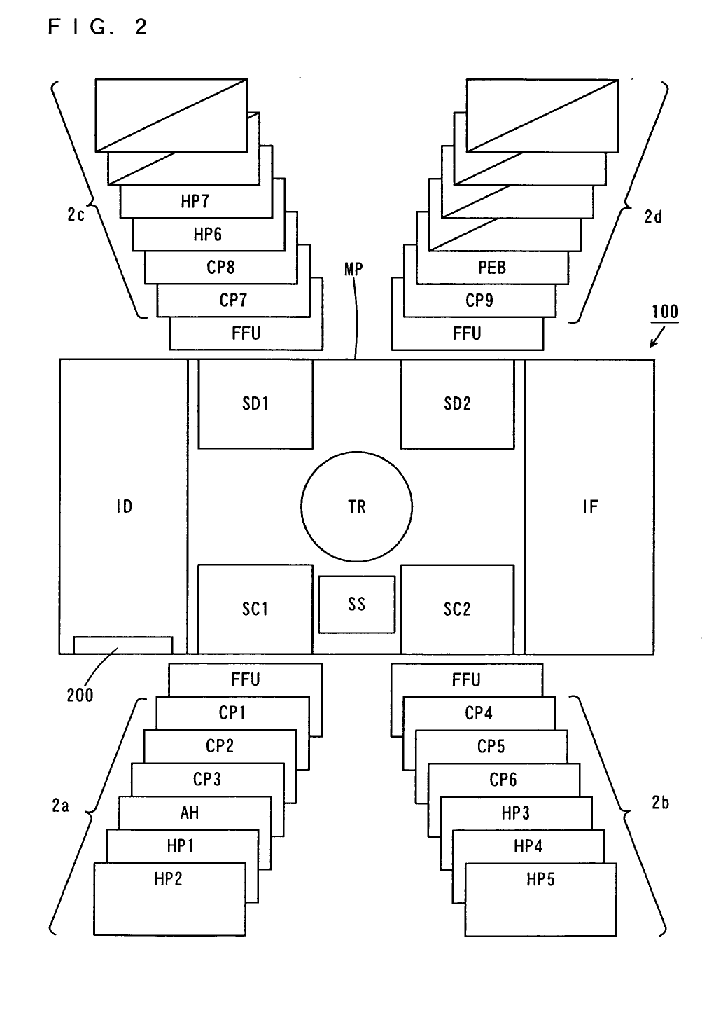

FIG. 1 is a schematic view showing the configuration of a substrate processing apparatus 100 according to the present embodiment, and FIG. 2 is a diagram for explaining the configuration of multi-stage thermal processing units 2a to 2d. FIG. 1(a) is a plan view of the substrate processing apparatus 100, and FIG. 1(b) is a front view of the substrate processing apparatus 100.

The substrate processing apparatus 100 shown in FIGS. 1(a) and 1(b) comprises an indexer ID, an interface IF, a processing unit section MP, and a controller 500.

As shown in FIG. 1(a), coating processing units (spin coaters) SC1 and SC2 for subjecting a substrate W to processing using a processing liquid and development processing units (spin developers) SD1 and SD2 are arranged at four corners of the processing unit section MP. A cleaning processing unit SS (a spin scraper) is arranged between the coating processing units SC1 and SC2.

The coating processing units SC1 and SC2 perform resist coating processing while rotating the substrate W. The development processing units SD1 and SD2 subject the substrate W, which has been exposed, to development processing while rotating the substrate W. The cleaning processing unit SS subjects a surface of the substrate W to cleaning processing while rotating the substrate W.

As shown in FIG. 2, cooling plates CP1 to CP3 for subjecting the substrate W to cooling processing are respectively provided in the first to third stages from the lowermost stage of the multi-stage thermal processing unit 2a. An adhesion processor AH for subjecting the substrate W to adhesion processing is provided in the fourth stage from the lowermost stage, and hot plates HP1 and HP2 for subjecting the substrate W to heating processing are respectively provided in the fifth and sixth stages from the lowermost stage.

Cooling plates CP4 to CP6 are respectively provided in the first to third stages from the lowermost stage of the multi-stage thermal processing unit 2b. Hot plates HP3 to HP5 are respectively provided in the fourth to sixth stages from the lowermost stage.

Cooling plates CP7 and CP8 are respectively provided in the first and second stages from the lowermost stage of the multi-stage thermal processing unit 2c, and hot plates HP6 and HP7 are respectively provided in the third and fourth stages from the lowermost stage. Although two stages from the lowermost stage are in an empty state in the substrate processing apparatus 100 according to the present embodiment, a hot plate, a cooling plate, or the other processing unit may be arranged therein depending on the applications and purposes.

A cooling plate CP9 is provided in the first stage from the lowermost stage of the multi-stage thermal processing unit 2d, and a post-exposure bake plate PEB for subjecting the substrate W to post exposure baking processing is provided in the second stage from the lowermost stage. Although two stages above the post-exposure back plate PEB are in an empty state, a hot plate, a cooling plate, or the other processing unit may be arranged depending on the applications and purposes.

The coating processing units SC1 and SC2, the development processing units SD1 and SD2, the cleaning processing unit SS, the hot plates HP1 to HP7, the cooling plates CP1 to CP9, the adhesion processor AH, and the post-exposure bake plate PEB are hereinafter generically referred to as a processing unit.

The indexer ID shown in FIG. 1(a) carries the substrate W into and out of the substrate processing apparatus 100. The processing unit section MP comprises a plurality of processing units for processing the substrate W and a substrate transport robot TR for carrying the substrate W into and out of each of the processing units. The details of the substrate transport robot TR will be described in detail later.

The interface IF transfers and receives the substrate W between an exposure device (not shown) and the processing unit section MP. The interface IF transfers the substrate W, which has been coated with resist in the processing unit section MP, to the exposure device and receives the substrate W, which has been exposed, from the exposure device. The interface IF comprises a robot (not shown) for transferring and receiving the substrate W to and from the substrate transport robot TR, and a buffer cassette (not shown) on which the substrate is placed. Consequently, the interface IF has the function of temporarily stocking the substrate W.

As shown in FIG. 1(b), the processing unit section MP has a tank storing a medical agent and a chemical cabinet 11 accommodating a piping or the like arranged in its lowermost part.

Furthermore, filter fan units FFU forming down flow of clean air are rrespectively provided on the coating processing units SC1 and SC2 and the development processing units SD1 and SD2. The multi-stage thermal processing units 2a to 2d for subjecting the substrate W to thermal processing are respectively provided on the filter fan units FFU and the cleaning processing unit SS. The configurations of the multi-stage thermal processing units 2a to 2d will be described later.

A filter fan unit FFU forming down flow of clean air is provided in an uppermost part of the processing unit section MP in the substrate processing apparatus 100. Consequently, an atmosphere inside the processing unit section MP is kept clean.

On a wall surface of the indexer ID in the substrate processing apparatus 100, there is provided an operation panel 200 on which information such as processing conditions of the substrate W are displayed and to which operation input is provided by a user. Further, a speaker 250 for outputting an alarm sound to the worker is provided on the wall surface of the indexer ID. A display lamp 260 is provided on the top of the indexer ID in the substrate processing apparatus 100.

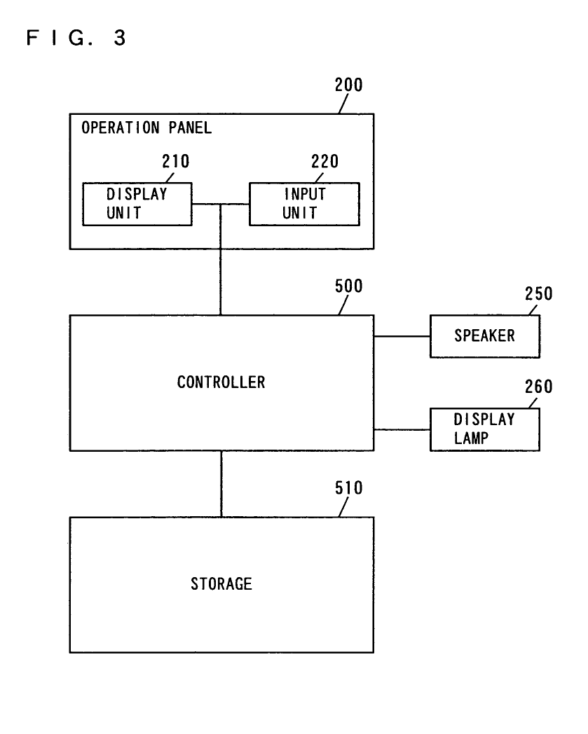

FIG. 3 is a block diagram for explaining the relationship with the controller 500 and the operation panel 200 in the substrate processing apparatus 100 shown in FIG. 1.

As shown in FIG. 3, a storage 510, the operation panel 200, the speaker 250, and the display lamp 260 are connected to the controller 500 in the substrate processing apparatus 100. The operation panel 200 comprises a display unit 210 and an input unit 220.

The display unit 210 in the operation panel 200 is composed of a liquid crystal display device or the like, the input unit 210 is composed of a touch panel or the like, the controller 500 is composed of a CPU (Central Processing Unit) or the like, and the storage 510 is composed of an external storage such as a hard disk, or the like.

The controller 500 shown in FIG. 3 transmits information for notifying the worker of the processing conditions of the substrate W in each of the processing units or the transfer conditions of the substrate W by the substrate transport robot TR to the display unit 210 in the operation panel 200, and receives information from the input unit 220 in the operation panel 200 by the worker.

The storage 510 shown in FIG. 3 previously stores maintenance information relating to the substrate processing apparatus 100, described later. The maintenance information means information relating to maintenance, and comprises maintenance, check, repair, part replacement, preparation, cleaning, and so on. The details of the maintenance information will be described later.

When a predetermined time period has elapsed since work was started on the basis of the maintenance information stored in the storage 510, or information relating to maintenance and a trouble are inputted from each of the units in the substrate processing apparatus 100, the controller 500 instructs each of the processing units to stop the operation, and instructs the speaker 250 to output an alarm sound and instructs the display lamp 260 to light up or flicker.

The worker can recognize the necessity of maintenance of the substrate processing apparatus 100 and the occurrence of a trouble by the alarm sound or the display lamp 260, and can maintain the substrate processing apparatus 100 reliably and in the early stages. The worker operates, when he or she terminates the maintenance of the substrate processing apparatus 100, the input unit 220 in the operation panel 200 to input the history of the maintenance (hereinafter referred to as maintenance history information). The controller 500 receives the maintenance history information, and stores the received maintenance history information in the storage 510.

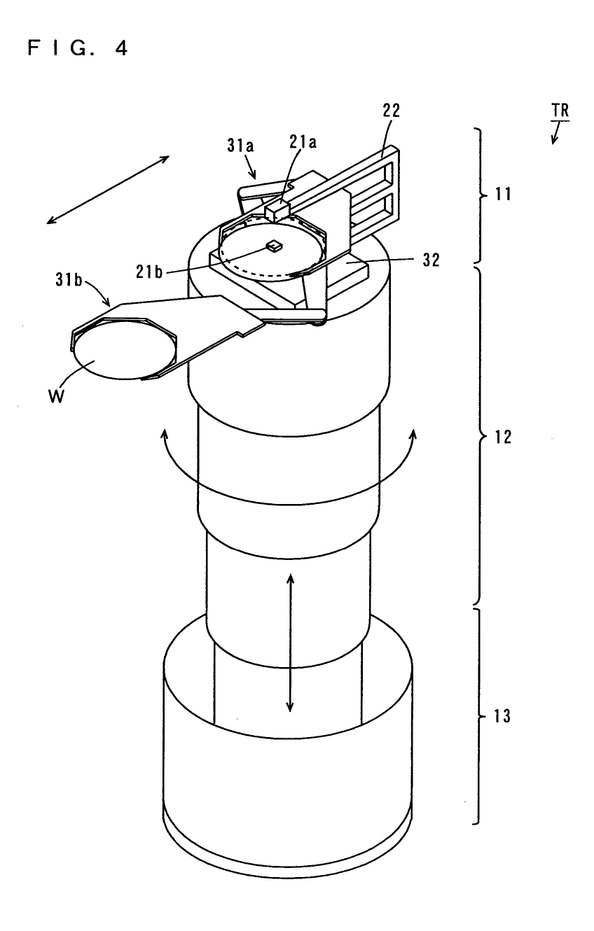

The details of the maintenance of the substrate transport robot TR will be then described as an example of the maintenance. FIG. 4 is a perspective view showing the appearance of the substrate transport robot TR shown in FIG. 1.

The substrate transport robot TR shown in FIG. 4 comprises an arm mechanism 11, a telescopic unit 12, and a rotating unit 13.

As shown in FIG. 4, the telescopic unit 12 is provided on the rotating unit 13, and the arm mechanism 11 is provided on the telescopic unit 12. The arm mechanism 11 is provided with arms 31a and 31b, a stage 32, a pair of sensor substrate sensors 21a and 21b, and a sensor fixing bracket 22.

The arm mechanism 11 has an arm driving mechanism (not shown) for moving the pair of arms 31a and 31b for holding the substrate W forward and backward provided in the stage 32. The telescopic unit 12 comprises a lifting mechanism (not shown) having a so-called telescopic structure for moving the arm mechanism 11 up and down in a vertical direction. The rotating unit 13 comprises a rotation driving mechanism (not shown) for rotating the arm mechanism 11 and the telescopic unit 12 around a vertical axis.

The arms 31a and 31b are respectively provided at different heights, and the arm 31a is provided above the arm 31b in the present embodiment. Thus, the arms 31 and 31 can perform a telescoping operation without interfering with each other.

Consequently, the arms 31a and 31b can respectively access the processing units, and can transfer and receive the substrate W to and from the processing unit.

For example, the arms 31a and 31b are alternately subjected to a telescoping operation, thereby making it possible to receive the substrate, which has already been processed, from the coating processing unit SC1 by the arm 31a and then, transfer the substrate W, which has not been processed yet, to the coating processing unit SC1 by the arm 31b.

The pair of substrate sensors 21a and 21b are mounted on the sensor fixing bracket 22. The substrate sensors 21a and 21b are provided such that it can be detected whether or not the substrate W exists on the arm 31a. Similarly, a pair of substrate sensors (not shown) for detecting whether or not the substrate W exists on the arm 31b is also provided.

Maintenance information displayed on the operation panel 200 will be then described. In the present embodiment, description is made of a case where the substrate sensors 21a and 21b in the substrate transport robot TR in the substrate processing apparatus 100 are maintained.

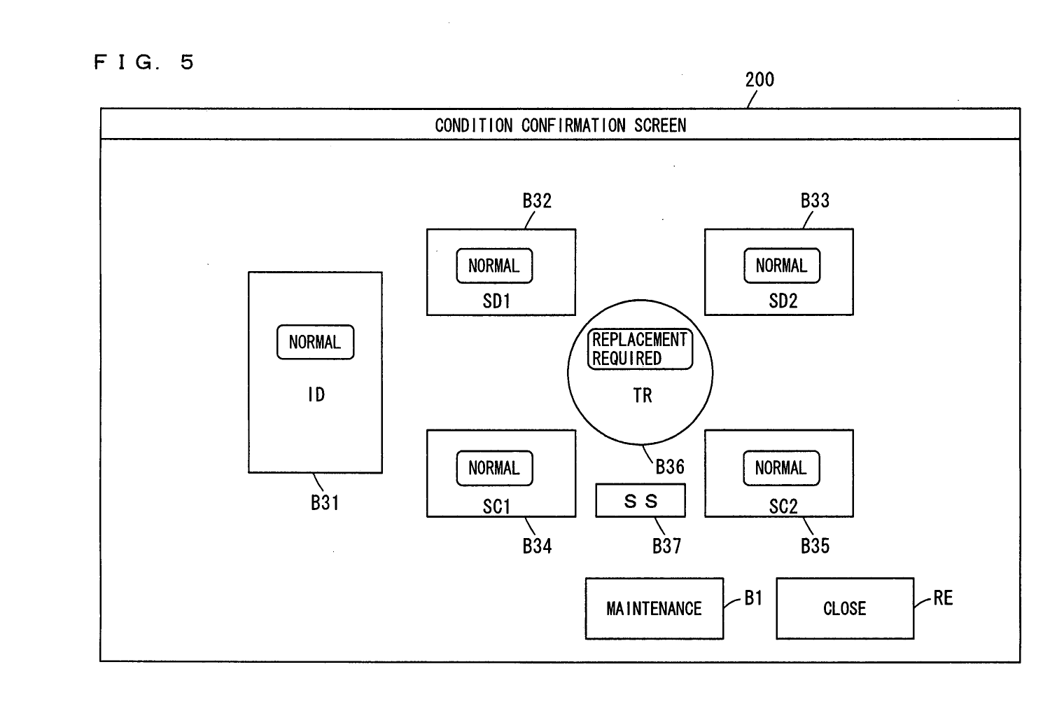

FIG. 5 is a diagram showing a condition confirmation screen displayed on the operation panel 200.

First, as shown in FIG. 5, the condition confirmation screen in the operation panel 200 comprises a condition display B31 of the indexer ID, a condition display B32 of the development processing unit SD1, a condition display B33 of the development processing unit SD2, a condition display B34 of the coating processing unit SC1, a condition display B35 of the coating processing unit SC2, a condition display B36 of the substrate transport robot TR, and a condition display B37 of the cleaning processing unit SS. Further, a “maintenance” button B1 and a “close” button RE are displayed in a lower part of the condition confirmation screen in the operation panel 200.

The worker confirms the condition displays B31 to B37 on the display unit 210 in the operation panel 200, thereby judging whether or not the indexer ID, the coating processing units SC1 and SC2, the development processing units SD1 and SD2, the cleaning processing unit SS, and the substrate transport robot TR in the substrate processing apparatus 100 are normal.

The worker presses the “close” button RE when all the condition displays B31 to B37 are “normal”. On the other hand, when any one of the condition displays B31 to B37 is “replacement required”, the worker presses the “maintenance” button B1, to proceed to maintenance.

On the condition confirmation screen in the operation panel 200 shown in FIG. 5, the condition display B36 of the substrate transport robot TR is “replacement required”. Consequently, the worker presses the “maintenance” button B1.

Consequently, the controller 500 shown in FIG. 3 selects maintenance information relating to the substrate transport robot TR stored in the storage 510, and gives the selected maintenance information to the display unit 210. Consequently, a maintenance screen including the maintenance information is displayed on the display unit 210 in the operation panel 200. In the present embodiment, the maintenance information includes moving image information for replacing the substrate sensors 21a and 21b in the substrate transport robot TR.

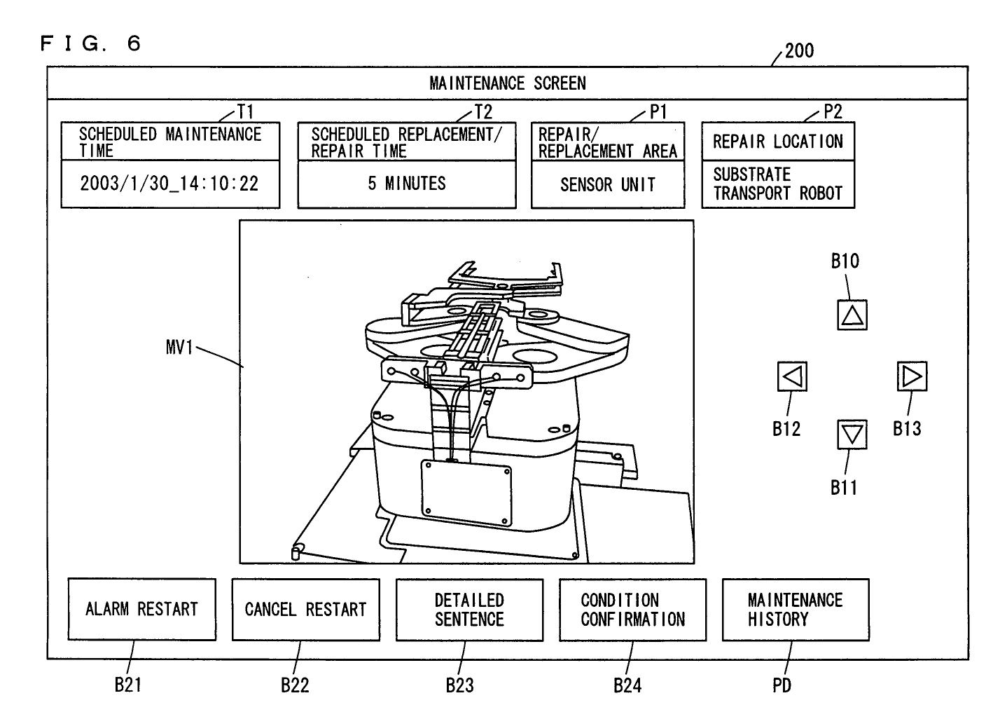

FIGS. 6 to 8 are diagrams showing a state where a maintenance screen is displayed on the operation panel 200.

The maintenance screen shown in FIGS. 6 to 8 include a scheduled maintenance time T1 representing the scheduled time when maintenance is to be performed, a scheduled replacement/repair time T2 representing a time spent until maintenance is terminated after starting to be performed, a repair/replacement area P1 where maintenance is performed, and a repair location P2 representing a device whose maintenance is required in its upper stage. The maintenance screen includes a moving image display section MV1 and scroll buttons B10 to B13 in its intermediate stage. The maintenance screen includes an “alarm restart” button B21, a “cancel restart” button B22, a “detailed sentence” button B23, a “condition confirmation” button B24, and a “maintenance history” button PD in its lower stage.

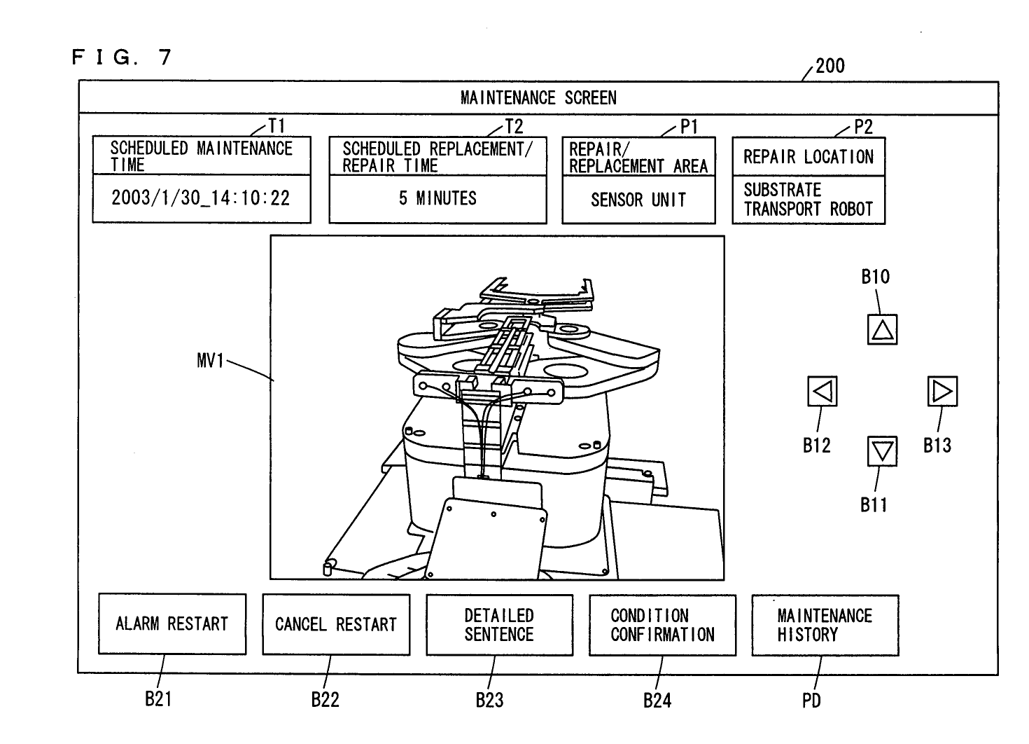

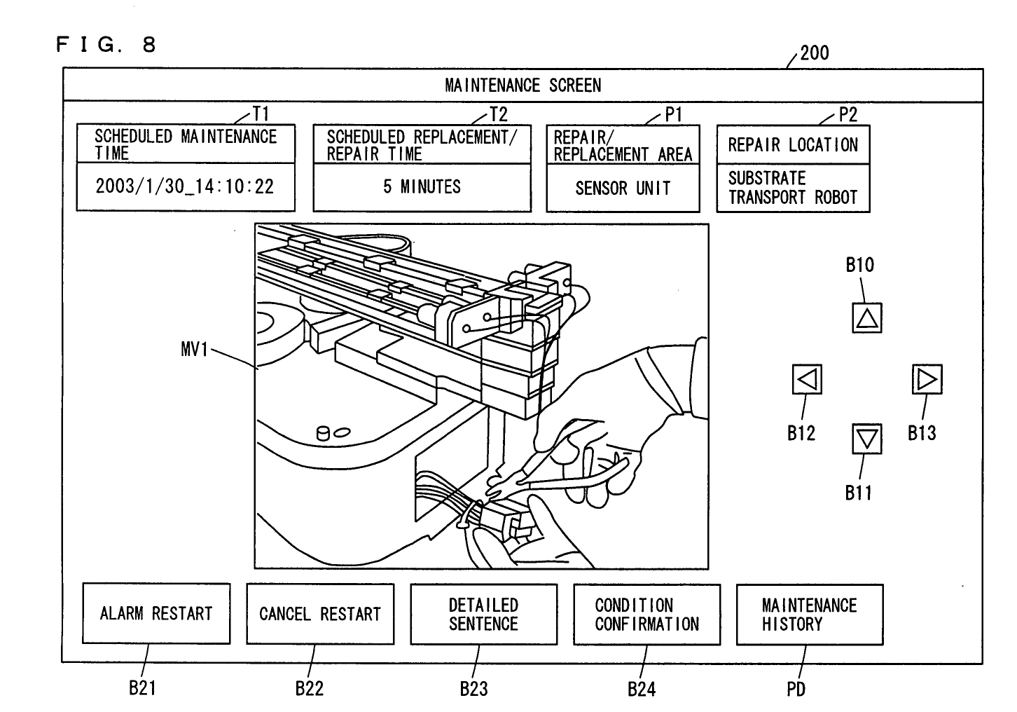

As shown in FIGS. 6 to 8, a moving image representing the procedure from the start to the termination of replacement of the substrate sensors 21a and 21b in the substrate transport robot TR is reflected on the moving image display section MV1. For example, the moving image display section MV1 shown in FIG. 6, the moving image display section MV1 shown in FIG. 7, the moving image display section MV1 shown in FIG. 8 respectively represent a moving image in a case where the replacement of the substrate transport robot TR is started, a moving image in a state where a part of the substrate transport robot TR is removed, and a moving image in a state where connectors of the substrate sensors 21a and 21b in the substrate transport robot TR are replaced.

The worker can estimate a working time period on the basis of the scheduled replacement/repair time T2 displayed on the operation panel 200, and can easily grasp a position to be maintained of the substrate processing apparatus 100 on the basis of the repair location P2 and the repair/replacement area P1. In this example, the worker can recognize that a time period during which maintenance is to be performed is five minutes by the scheduled replacement/repair time T2, and recognize that a sensor unit, which is a position to be maintained in the substrate transport robot TR, should be maintained by the repair location P2 and the repair/replacement area P1.

The worker can grasp the procedure for replacement of the substrate sensors 21a and 21b by seeing the moving image displayed on the moving image display section MV1 in the operation panel 200. The substrate sensors 21a and 21b in the substrate transport robot TR can be replaced in a short time and accurately in accordance with the procedure for replacement displayed on the moving image display section MV1.

The worker can easily grasp the time when maintenance is to be performed by seeing the scheduled maintenance time T1. In this example, the worker can recognize that the time when maintenance should be performed by the scheduled maintenance time T1 is 14:10:22, Jan. 30, 2003. Consequently, the worker can prevent the time when maintenance is to be performed from being forgotten. Further, the worker can reliably recognize that maintenance should be performed by an alarm sound produced by the speaker 250 or lighting by the display lamp 260, for example.

When attention is urged to be paid to the worker in addition to the display of the moving image on the moving image display section MV1, a beep sound is outputted from the speaker 250, or a message may be displayed on the operation panel 200.

In the present embodiment, the description of a maintenance method indicated in a plurality of languages may be stored in the storage 510. In this case, the user can select the desired language by the input unit 220. Consequently, the description of the maintenance method indicated in the selected language is outputted from the speaker 250.

The description of a maintenance method indicated in a plurality of languages may be stored in the storage 510. In this case, the user can select the desired language by the input unit 220. Consequently, the description of the maintenance method indicated in the selected language is displayed on the display unit 210 in the operation panel 200.

When the worker presses the “alarm restart” button B21, the alarm sound is stopped. When the worker presses the “alarm restart” button B21 again, processing for the substrate W is resumed.

On the other hand, when the “cancel restart” button B22 is pressed, the alarm sound is stopped. When the worker presses the “alarm restart” button B22 again, processing up to the present time point is canceled, so that processing for a new substrate W is resumed.

When the processing for the substrate W is not resumed after the “alarm restart” button B21 or the “cancel restart” button B22 is pressed, the controller 500 generates a new alarm sound from the speaker 250 or emits light from the display lamp, to continue the stopped state of the substrate processing apparatus 100. Consequently, the worker cannot forget to maintain the substrate processing apparatus 100.

When the worker presses the “detailed sentence” button B23, the contents of the display on the operation panel 200 are switched from the maintenance screen to a detailed sentence screen, described later. The worker presses the “detailed sentence” button B23 so that the controller 500 selects data representing a detailed sentence from the maintenance information stored in the storage 510 and gives the selected data to the display unit 210 in the operation panel 200. Consequently, the display on the operation panel 200 is switched to the detailed sentence screen.

When the worker presses the “condition confirmation” button B24, the contents of the display on the operation panel 200 are switched to the condition confirmation screen shown in FIG. 5, described above.

When the worker presses the “maintenance history” button PD, the contents of the display on the operation panel 200 are switched to a maintenance history screen, described later. The worker presses the “maintenance history” button PD so that the controller 500 selects data representing maintenance history from the maintenance information stored in the storage 510 and feeds the selected data to the display unit 210 in the operation panel 200. Consequently, the display on the operation panel 200 is switched to the maintenance history screen.

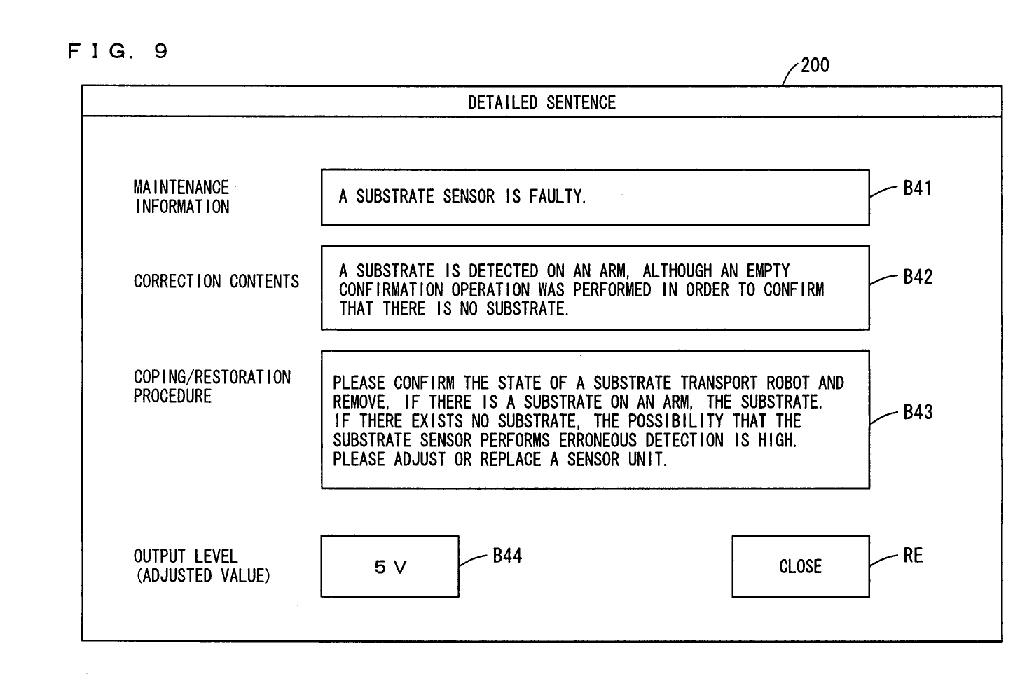

FIG. 9 is a diagram showing a state where the detailed sentence screen is displayed on the operation panel 200.

The detailed sentence screen shown in FIG. 9 comprises a maintenance information display section B41 representing the contents of maintenance, a correction contents display section B42 representing reasons why maintenance is required, a coping/restoration procedure display section B43 representing a maintenance method in performing maintenance, an output level (adjustment value) display section B44 representing a value to be adjusted in performing maintenance, and a “close” button RE.

The worker can grasp the contents of maintenance on the basis of the contents displayed on the maintenance information display section B41.

In this example, it can be recognized that the contents of maintenance are “a substrate sensor is faulty” by the maintenance information display section B41. The worker can grasp reasons why maintenance is required, which is displayed on the correction contents display section B42, and the method of maintenance, which is displayed on the coping/restoration procedure display section B43. In this example, conditions “A substrate was detected on an arm, although an empty confirmation operation was performed in order to confirm that there is no substrate” can be grasped by the correction contents display section B42, and a coping method “Please confirm the state of a substrate transport robot and remove, if there is a substrate on the arm, the substrate. If there is no substrate, the possibility that a substrate sensor performs erroneous detection is high. Please adjust or replace a sensor unit” can be grasped by the coping/restoration procedure display section B43.

In this case, the worker can grasp reasons why maintenance is required and a maintenance method for improving the reasons, so that the maintenance can be reliably performed.

Furthermore, the worker can easily grasp a value to be adjusted in the maintenance by the output level (adjustment value) display section B44. In this example, the worker can easily recognize that an output adjustment value of the sensor, in which a sensor unit has been replaced, should be adjusted to “5 V” by the output level display section B44.

The worker can easily grasp values to be adjusted of the substrate sensors 21a and 21b on the basis of the output level display section B44 in the operation panel 200 without confirming the values to be adjusted using an instruction manual. Consequently, the adjustment can be made in a short time without repeating the adjustment of the substrate sensors 21a and 21b.

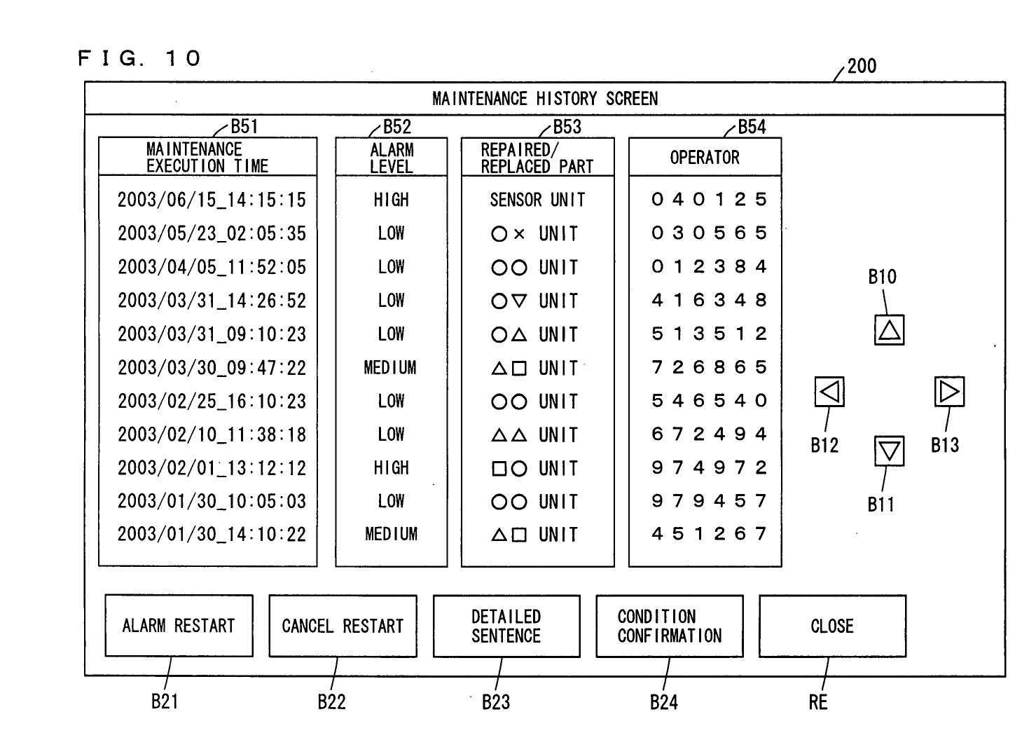

Description is then made of a case where the “maintenance history” button PD in the operation panel 200 shown in FIGS. 6 to 8 is pressed. FIG. 10 is a diagram showing a state where the maintenance history screen is displayed on the operation panel 200.

The maintenance history screen shown in FIG. 10 includes a maintenance execution time display section B51 representing the time when past maintenance was performed, an alarm level display section B52 representing the level of a past alarm, a repaired/replaced part display section B53 representing a part replaced in the past maintenance, and an operator display section B54 representing an operator who performed the past maintenance.

The worker can grasp the frequency at what maintenance is performed by the maintenance execution time display section B51, can further judge whether or not an alarm is operated at a high level by the alarm level display section B52, and can presume the time when a part to be replaced is replaced by the repaired/replaced part B53. Further, a person who performs maintenance work can be also confirmed by the operator display section B54.

For example, the worker presses scroll buttons B10 to B13 so that display on the maintenance execution time display section B51, the alarm level display section B52, the repaired/replaced part B53, and the operator display section B54 can be scrolled up and down. Consequently, past maintenance history information relating to the substrate processing apparatus 100 can be displayed on the maintenance history screen.

In this case, the worker can grasp past maintenance conditions of the substrate processing apparatus 100 by confirming the maintenance history in the maintenance execution time B51, the alarm level B52, and the repaired/replaced part B53.

### (2) Correspondence Between Each Constituent Element in Claims and Each Unit in Embodiment

In the present embodiment, the storage 510 corresponds to a storage device, the display unit 210 in the operation panel 200 corresponds to a display device, the input unit 220 in the operation panel 200 corresponds to an operation unit, the speaker 250 corresponds to a voice output device, and the speaker 250 or the display lamp 260 correspond to an alarm output device.

The scheduled replacement/repair time T2 corresponds to time information relating to a time period required for maintenance, the repair/replacement area P1 and the repair location P2 correspond to positional information relating to a position to be maintained, the output level display section B44 corresponds to adjustment value information relating to a value to be adjusted in maintenance, the maintenance information B41, the correction contents display section B42 or the coping/restoration procedure display section B43 corresponds to character information representing a maintenance method, the scheduled maintenance time T1 corresponds to notification information and the time when maintenance is to be performed, the condition displays B31 to B37 on the condition confirmation screen correspond to information indicating whether or not maintenance is required, and the maintenance history screen corresponds to maintenance history information.

### (3) Another Embodiment

As a storage device, the storage 510 composed of an external storage device such as a hard disk may be replaced with semiconductor storage devices such as a RAM (Random Access Memory), a ROM (Read-On Memory), and a nonvolatile memory. Alternatively, recording media such as a flexible disk, a CD (Compact Disc), or a DVD (Digital Versatile Disc) may be used, or a memory card may be used.

As a display device, the display unit 210 composed of a liquid crystal display device may be replaced with various types of display devices such as a CRT (Cathode-Ray Tube) and a plasma display panel.

As an operation unit, the input unit 220 composed of a touch panel can be replaced with a keyboard, a pointing device, and various switches.

As an alarm output device, the speaker 250 may be replaced with voice output devices such as a headphone, or the display lamp 260 may be replaced with various light sources such as a light emitting diode. Alternatively, various display devices such as a liquid crystal display device may be used.

As a voice output device, the speaker 250 may be replaced with voice output devices such as a headphone.

Although the present invention has been described and illustrated in detail, it is clearly understood that the same is by way of illustration and example only and is not to be taken by way of limitation, the spirit and scope of the present invention being limited only by the terms.

1. A substrate processing apparatus that subjects a substrate to predetermined processing, comprising:
a storage device that stores moving image information representing a method of maintaining the substrate processing apparatus; and
a display device that displays the moving image information stored in the storage device as a moving image.

2. The substrate processing apparatus according to claim 1, wherein
the storage device further stores time information relating to a time period required for the maintenance, and
the display device displays the time information relating to the time period required for the maintenance stored in the storage device.

3. The substrate processing apparatus according to claim 1, wherein
the storage device further stores positional information relating to a position to be maintained, and
the display device displays the positional information relating to the position to be maintained stored in the storage device.

4. The substrate processing apparatus according to claim 1, wherein
the storage device further stores adjustment value information relating to a value to be adjusted in the maintenance, and
the display device displays the adjustment value information relating to the value to be adjusted in the maintenance stored in the storage device.

5. The substrate processing apparatus according to claim 1, wherein
the storage device further stores character information representing the maintenance method, and
the display device displays the character information representing the maintenance method stored in the storage device.

6. The substrate processing apparatus according to claim 5, wherein the character information representing the maintenance method includes character information indicated in a plurality of languages, and said substrate processing apparatus further comprising
an operation unit that selects the character information indicated in the plurality of languages stored in the storage device,
the display device displaying the character information indicated in the language selected by an operation of the operation unit.

7. The substrate processing apparatus according to claim 1, wherein the storage device further stores character information representing the maintenance method, and said substrate processing apparatus further comprising
a voice output device that outputs the maintenance method stored in the storage device by voice.

8. The substrate processing apparatus according to claim 7, wherein the character information representing the maintenance method includes character information indicated in a plurality of languages, and said substrate processing apparatus further comprising
an operation unit that selects the character information indicated in the plurality of languages stored in the storage device,
the voice output device outputting the character information indicated in the language selected by an operation of the operation unit by voice.

9. The substrate processing apparatus according to claim 1, wherein
the storage device further stores notification information for notifying a worker of the time when maintenance is to be performed, and
the display device displays the notification information for notifying the worker of the time when maintenance is to be performed stored in the storage device.

10. The substrate processing apparatus according to claim 9, further comprising
an alarm output device that outputs an alarm to a worker on the basis of the notification information.

11. The substrate processing apparatus according to claim 9, wherein
the alarm output device outputs an alarm sound on the basis of the notification information.

12. The substrate processing apparatus according to claim 9, wherein
the alarm output device displays an alarm on the basis of the notification information.

13. The substrate processing apparatus according to claim 1, wherein
the storage device further stores history information relating to the history of the maintenance of the substrate processing apparatus.

14. The substrate processing apparatus according to claim 1, wherein
the display device further displays information indicating whether or not the maintenance of each unit in the substrate processing apparatus is required.

15. The substrate processing apparatus according to claim 14, wherein
the display device switches and displays the information indicating whether or not the maintenance is required and the moving image information.

16. A substrate processing method for subjecting a substrate to predetermined processing, comprising the steps of:
storing moving image information representing a method of maintaining a substrate processing apparatus; and
displaying the stored moving image information as a moving image.
